(19) United States
(12) Patent Application Publication
(10) Pub. No.: US 2016/0068257 A1
(43) Pub. Date: Mar. 10, 2016

(54) BOUNDARY LAYER CONTROL FOR THICKNESS AND CAMBER MORPHING OF AERODYNAMIC SURFACES

(71) Applicant: AIRBUS GROUP INDIA PRIVATE LIMITED, Bangalore (IN)

(72) Inventor: ANURAG SHARMA, Bangalore (IN)

(21) Appl. No.: 14/833,157

(22) Filed: Aug. 24, 2015

(30) Foreign Application Priority Data
Sep. 9, 2014 (IN) 4424/CHE/2014

(51) Int. Cl. B64C 21/08; B64C 5/10; B64C 3/26

(52) U.S. Cl. CPC B64C 21/08; B64C 3/26; B64C 5/10

(57) ABSTRACT

An aerodynamic structure and a method of boundary layer control for thickness and camber morphing of aerodynamic surfaces in the aerodynamic structure are disclosed. In one embodiment, smart material controlled slots are provided along chord length and span length of the aerodynamic surfaces and leading edges of moveable control surfaces. Further, fluid is distributed on the aerodynamic surfaces and the leading edges of moveable control surfaces through the provided smart material controlled slots to vary fluid thickness of a boundary layer such that free stream fluid paths are modified around the aerodynamic surfaces to achieve an apparent change in a camber and thickness.

### RELATED APPLICATIONS

Benefit is claimed under 35 U.S.C. 119(a)-(d) to Foreign application Serial No. 4424/CHE/2014 filed in India entitled “BOUNDARY LAYER CONTROL FOR THICKNESS AND CAMBER MORPHING OF AERODYNAMIC SURFACES”, on Sep. 9, 2014, by AIRBUS GROUP INDIA PRIVATE LIMITED, which is herein incorporated in its entirety by reference for all purposes.

### TECHNICAL FIELD

Embodiments of the present subject matter generally relate to boundary layer control of aerodynamic surfaces, and more particularly, to boundary layer control for thickness and camber morphing of the aerodynamic surfaces.

### BACKGROUND

Typically, aerodynamic surfaces having low cambers are used in an aircraft to reduce drag divergence during flight. However, these aerodynamic surfaces are not suitable to produce high lift at low airspeeds. In order to produce high lift at low airspeeds, existing techniques propose using moveable control surfaces, such as ailerons, flaps, slats, elevators, rudders, and the like, on leading edges and/or trailing edges of the aerodynamic surfaces. These moveable control surfaces may be deflected during flight to improve lift performances of the aerodynamic surfaces at the low airspeeds. For example, at low airspeeds, moveable control surfaces extended downward to produce a high camber on an aerodynamic surface which permits the aerodynamic surface to produce high lift. However, using these moveable control surfaces increases weight and size of aerodynamic structures. Also, in modern fly by a wire aircraft, these control surfaces move about a neutral point throughout the flight for optimized maneuvering and load alleviation leading to wear and tear and fatigue in actuators and supporting structures of the aerodynamic surfaces.

### SUMMARY

An aerodynamic structure and a method of boundary layer control for thickness and camber morphing of aerodynamic surfaces in the aerodynamic structure are disclosed. According to one aspect of the present subject matter, smart material controlled slots are provided along chord length and span length of the aerodynamic surfaces and leading edges of moveable control surfaces. Further, fluid is distributed on the aerodynamic surfaces and the leading edges of moveable control surfaces through the provided smart material controlled slots to vary fluid thickness of a boundary layer such that free stream fluid paths are modified around the aerodynamic surfaces to achieve an apparent change in a camber and thickness.

According to another aspect of the present subject matter, the aerodynamic structure includes aerodynamic surfaces having the moveable control surfaces. For example, the aerodynamic structure includes an aircraft and the like. Further, the aerodynamic structure includes smart material controlled slots formed along chord length and span length of the aerodynamic surfaces and leading edges of the moveable control surfaces. In one embodiment, fluid is distributed on the aerodynamic surfaces and the leading edges of the moveable control surfaces through the smart material controlled slots to vary fluid thickness of a boundary layer such that free stream fluid paths are modified around the aerodynamic surfaces to achieve an apparent change in a camber and thickness.

The structure and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 is a flow diagram of an example method of boundary layer control for thickness and camber morphing of aerodynamic surfaces, according to one embodiment;

FIG. 2 illustrates a top view of an aircraft including smart material controlled slots on wing surfaces and associated moveable control surfaces, according to one embodiment;

FIG. 3 is a schematic diagram illustrating an example airfoil of an aircraft wing surface including smart material controlled slots, according to one embodiment;

FIG. 4A is a schematic diagram illustrating an airfoil of an aerodynamic surface in the context of the present invention; and

FIG. 4B is a schematic diagram illustrating an airfoil of the aerodynamic surface, of FIG. 4A, after controlling a boundary layer of the aerodynamic surface, according to one embodiment.

The drawings described herein are for illustration purposes only and are not intended to limit the scope of the present disclosure in any way.

### DETAILED DESCRIPTION

An aerodynamic structure and a method of boundary layer control for thickness and camber morphing of aerodynamic surfaces in the aerodynamic structure are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

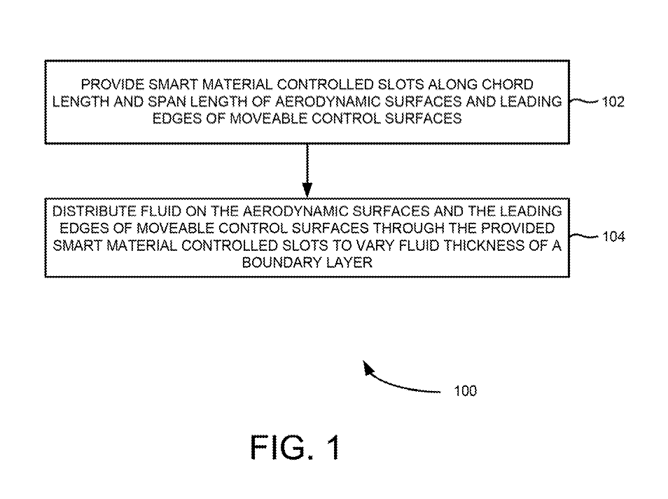

FIG. 1 is a flow diagram 100 of an example method of boundary layer control for thickness and camber morphing of aerodynamic surfaces, according to one embodiment. For example, the aerodynamic surfaces include aircraft wing surfaces, stabilizer surfaces, horizontal tail plane surfaces, vertical tail plane surfaces and the like. At block 102, smart material controlled slots are provided along chord length and span length of the aerodynamic surfaces and leading edges of moveable control surfaces. For example, the moveable control surfaces include ailerons, flaps, slats, elevators, rudders, and the like. The smart material controlled slots may include, but not limited to, slots formed of smart materials or slots controlled by actuators made of smart materials. The smart materials may include, but not limited to, piezoelectric materials, shape memory alloys, composite skins with integrated shape memory alloys and the like. For example, the smart material controlled slots include variable sized slots and/or fixed sized slots. In one example embodiment, the smart material controlled slots are provided along chord length and span length of upper and/or lower aircraft wing surfaces. In another example embodiment, the smart material controlled slots are provided along chord length and span length of left and/or right vertical tail plane surfaces. In an example implementation, the smart material controlled slots are provided at positions, beginning before a laminar flow separation point, of about 10%-75% of the chord length of the aerodynamic surfaces. The laminar flow separation point is a point where laminar flow separates or detaches from an aerodynamic surface due to adverse pressure gradient or inability to follow the contour precisely or transitions to turbulent flow.

At block 104, fluid is distributed on the aerodynamic surfaces and the leading edges of the moveable control surfaces through the provided smart material controlled slots to vary fluid thickness of a boundary layer such that free stream fluid paths are modified around the aerodynamic surfaces to achieve an apparent change in thickness (span wise and chord wise thickness) and/or a camber. For example, the fluid distributed on the aerodynamic surfaces and the leading edges of the moveable control surfaces includes air obtained from cabin outlets, engine bleed, avionics cooling outlets and the like of an aircraft. In some examples, high pressure air from a bottom surface of an aircraft wing can be used to maintain top surface laminar flow over a higher chord length for reducing drag In one embodiment, the fluid is distributed on the leading edges of the moveable control surfaces at a small angle to the free stream fluid paths for modifying the fluid thickness of the boundary layer. In this embodiment, the modified boundary layer helps the free stream fluid paths to curve around the moveable control surfaces without separation and can alter the camber and thickness of the aerodynamic surface as seen by the free stream fluid paths.

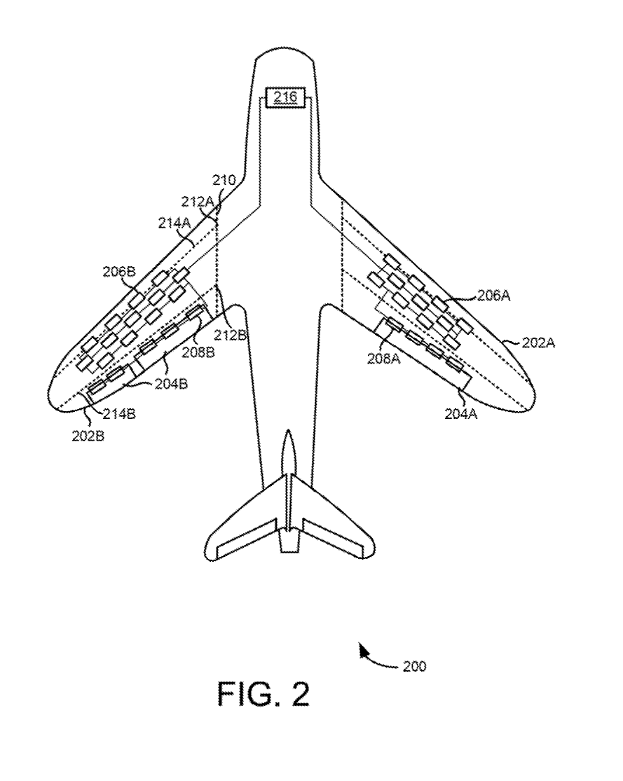

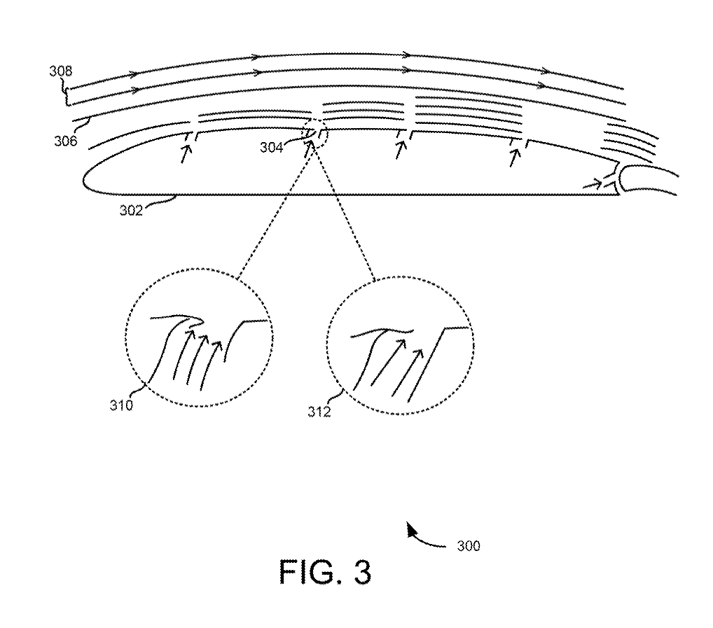

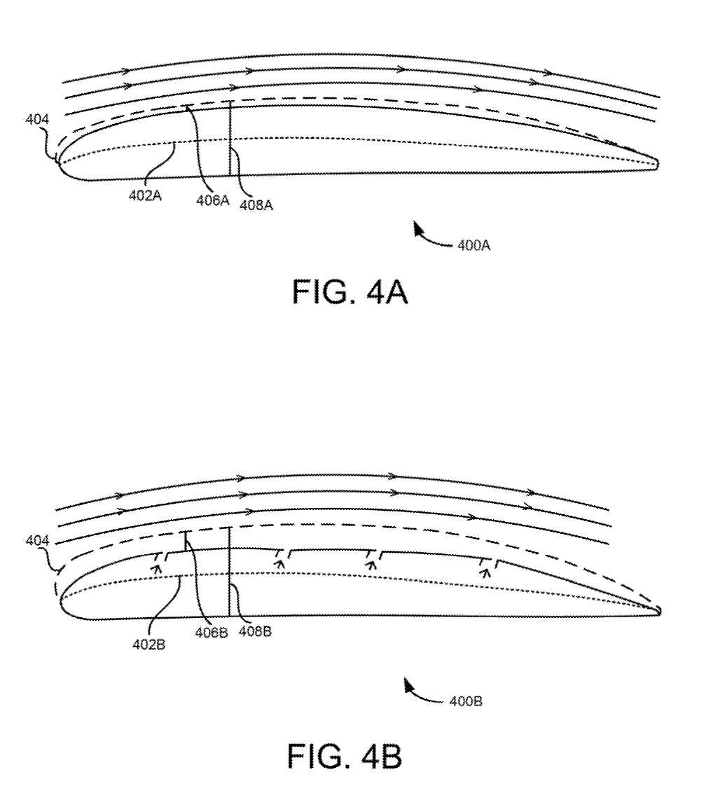

In some example embodiments, the distribution of the fluid through the smart material controlled slots is controlled for enhancing the thickness of the fluid at various percentages of the chord length along the span length to change twist, camber and/or thickness of an airfoil for maneuvering, load control or alleviation and twist control of the aerodynamic surfaces. The load alleviation may be achieved by altering fluid flows by controlling the slots. This is explained in more detail with reference to FIG. 3. The boundary layer control for thickness and camber morphing of the aerodynamic surfaces is explained in more detail with reference to FIG. 2. Example camber of an aerodynamic surface before and after varying fluid thickness of a boundary layer is shown in FIGS. 4A and 4B, respectively.

Referring to FIG. 2, which illustrates a top view of an aerodynamic structure (e.g., an aircraft 200) including smart material controlled slots on wing surfaces 202A and 202B and associated moveable control surfaces 204A and 204B, according to one embodiment. As shown in FIG. 2, the aircraft 200 includes smart material controlled slots 206A and 206B formed along chord length and span length of the wing surfaces 202A and 2026, respectively. Also, the aircraft 200 includes smart material controlled slots 208A and 208B formed on leading edges of the moveable control surfaces 204A and 204B, respectively. For example, the moveable control surfaces 204A and 204B include ailerons, flaps, slats, elevators, rudders, and the like. In the example shown in FIG. 2, the smart material controlled slots 206A and 208A are interconnected to each other and the smart material controlled slots 206B and 208B are interconnected to each other. In one example, smart material controlled slots may include, but not limited to, slots formed of smart materials or slots controlled by actuators made of smart materials. In this example, the smart material controlled slots include variable sized slots and/or fixed sized slots. The smart materials may include piezoelectric materials, shape memory alloys, composite skins with integrated shape memory alloys and the like. In an example implementation, the smart material controlled slots 206A and 206B are formed at positions, beginning before a laminar flow separation point, of about 10%-75% of the chord length of the wing surfaces 202A and 202B, respectively. For example, point 212A is at 10% of chord length 210 of the wing surface 202B and point 212B is at 75% of the chord length 210 of the wing surface 202B. In the example illustrated in FIG. 2, span lengths 214A and 214B indicate span length of the wing surface 202B at 10% of the chord length 210 and 75% of the chord length 210, respectively. Further, a flight control system 216 (e.g., a computing system and the like), residing at a cockpit of the aircraft 200, is connected to the smart material controlled slots 206A, 206B, 208A and 208B via a bus link.

Further, fluid is distributed on the wing surfaces 202A and 202B and the leading edges of the moveable control surfaces 204A and 204B through the associated smart material controlled slots 206A, 206B, 208A and 208B, respectively, to vary fluid thickness of a boundary layer such that free stream fluid paths are modified around the wing surfaces 202A and 202B to achieve an apparent change in thickness and/or camber. For example, the fluid distributed on the wing surfaces 202A and 202B and the leading edges of the moveable control surfaces 204A and 204B includes air obtained from cabin outlets, engine bleed, avionics cooling outlets and the like of the aircraft 200.

In some example embodiments, the distribution of the fluid through the smart material controlled slots is controlled for enhancing the thickness of the fluid among span length and at different percentages of chord lengths to change twist, camber and/or thickness of the wing surfaces 202A and 202B for maneuvering, load control or alleviation and twist control of the wing surfaces 202A and 202B, respectively. The load alleviation may be achieved by altering fluid flows through the associated slots 206A, 206B, 208A and 208B. This is explained in more detail with reference to FIG. 3. In the example illustrated in FIG. 2, the flight control system 216 controls the distribution of the fluid by sending electric and control signals to the smart material controlled slots 206A, 206B, 208A and 208B to change their positions. The flight control system 216 sends the electric and control signals to the smart material controlled slots 206A, 206B, 208A and 208B based on flow regime (i.e., flow characteristics and Reynolds number) and separation behavior at different densities, altitudes, control deflection conditions and angle of attacks measured by aircraft sensors.

Referring now to FIG. 3, which is a schematic diagram 300 illustrating an example airfoil 302 of an aircraft wing surface including smart material controlled slots, according to one embodiment. As shown in FIG. 3, fluid is distributed on the aircraft wing surface and leading edges of movable control surfaces through the smart material controlled slots 304 to vary fluid thickness of a boundary layer (e.g., a boundary layer 306) such that free stream fluid paths (e.g. free stream fluid paths 308) are modified around the aircraft wing surface to achieve an apparent change in thickness and a camber. Example camber before and after varying fluid thickness of a boundary layer is shown in airfoils 400A and 400B of FIGS. 4A and 4B, respectively, (i.e., camber 402A and 402B in FIGS. 4A and 4B, respectively). For example, the smart material controlled slots 304 can be in a fully opened position (i.e., actuated) for high flow (as shown in 310) or in a normal position (i.e., non-actuated) for low flow (as shown in 312) or in a closed position. In one example embodiment, the fluid flow is controlled for enhancing the thickness of the fluid among span length and different chord lengths to change twist, camber and/or thickness of the airfoil for load control or alleviation. In this example embodiment, the fluid flow is controlled based on temperature around the aerodynamic surface. In one embodiment, load alleviation is achieved by altering the fluid flows by controlling the slots 304 for various positions. In this embodiment, areas of lift are shifted or tailored by redistributing the fluid along chord length and span length.

Referring now to FIG. 4A, which is a schematic diagram illustrating an airfoil 400A of an aerodynamic surface, in the context of the present invention. As shown in FIG. 4A, the airfoil 400A includes a camber 402A. Further as shown in FIG. 4A, fluid thickness of a boundary layer 404 is indicated as 406A and a distance between the boundary layer 404 and a bottom surface of the airfoil 400A is indicated as 408A.

Referring now FIG. 4B, which is a schematic diagram illustrating an airfoil 400B of the aerodynamic surface, of FIG. 4A, after controlling a boundary layer of the aerodynamic surface, according to one embodiment. As shown in FIG. 4B, the airfoil 400B includes a camber 402B. Further as shown in FIG. 4B, fluid thickness of the boundary layer 404 is indicated as 406B, which is greater than the fluid thickness 406A shown in FIG. 4A, and a distance between the boundary layer 404 and a bottom surface of the airfoil 400B is indicated as 408B, which is greater than the distance 408A shown in FIG. 4A. Thus, indicating that the camber 402A shown in FIG. 4A is apparently changed to the camber 402B.

In various embodiments, the systems and methods described in FIGS. 1-3 and 4B propose a technique of boundary layer control for thickness and camber morphing of aerodynamic surfaces having movable control surfaces by distributing fluid (e.g., air obtained from cabin outlets, engine bleed, and avionics cooling outlets and the like of an aircraft) through smart material controlled slots provided on the aerodynamic surfaces and the movable control surfaces. Thus, delaying a separation/transition chord wise position and reducing size of the aerodynamic surfaces and movable control surfaces for lighter, cleaner and smaller aerodynamic surfaces. This in turn reduces material cost, manufacturing part counts and weight of the aerodynamic surfaces.

Further, distribution of warm cabin/avionics air on the aerodynamic surfaces and leading edges of the movable control surfaces reduces icing and need for anti-ice systems in the aircraft. In this case, ice breaking is performed by momentarily varying camber whenever lower temperatures are detected by monitoring resistivity in the smart material controlled slots itself. Furthermore, an intelligent load alleviation function can be achieved over whole aerodynamic surface and full flight regime reducing weights/stiffness of wings/tails. In addition, this technique can reduce need for constant movement of the movable control surfaces about a neutral for small corrections reducing wear and tear and reliability concerns for the movable control surfaces. Also, this technique reduces induced drag from control deflections throughout flight regime and reduces fuel consumption and can decrease need for actuators and hydraulics. The wing can achieve controlled warping piezo-electrically for performing all functions of the movable control surfaces and empennage functions. Further, the wing strain can also be determined via these smart material controlled slots integral to the skin by measuring resistivity change which is proportional to strain which can modulate fluid flow to reduce it by shifting the peak loads better over the aerodynamic surface. Furthermore, noise abatement from flow control and aero elastic coupling optimization between different surfaces (wing—empennage, engine-wing, etc.,) is possible. In addition, vortex shedding can be tailored at different flight regimes to reduce drag by flow separation control.

Although certain methods and structures of manufacture have been described herein, the scope of coverage of this patent is not limited thereto. To the contrary, this patent covers all methods and structures of manufacture fairly falling within the scope of the appended claims either literally or under the doctrine of equivalents.

What is claimed is:

1. A method of boundary layer control for thickness and camber morphing of aerodynamic surfaces, comprising:
providing smart material controlled slots along chord length and span length of aerodynamic surfaces and leading edges of moveable control surfaces; and
distributing fluid on the aerodynamic surfaces and the leading edges of moveable control surfaces through the provided smart material controlled slots to vary fluid thickness of a boundary layer such that free stream fluid paths are modified around the aerodynamic surfaces to achieve an apparent change in thickness and a camber.

2. The method of claim 1, wherein the smart materials comprise at least one of piezoelectric materials, shape memory alloys and composite skins with integrated shape memory alloys.

3. The method of claim 1, wherein the fluid comprises air obtained from at least one of cabin outlets, engine bleed, and avionics cooling outlets of an aircraft.

4. The method of claim 1, wherein the aerodynamic surfaces comprise aircraft wing surfaces, vertical tail plane surfaces, horizontal tail plane surfaces and stabilizer surfaces.

5. The method of claim 1, wherein the moveable control surfaces comprise ailerons, flaps, slats, elevators, and rudders.

6. The method of claim 1, wherein the smart material controlled slots are provided at positions, beginning before a laminar flow separation point, of about 10%-75% of the chord length of the aerodynamic surfaces.

7. The method of claim 1, wherein the smart material controlled slots comprise at least one of variable sized slots and fixed sized slots.

8. The method of claim 1, wherein the smart material controlled slots comprise at least one of slots controlled by actuators made of smart materials and slots formed of smart materials.

9. The method of claim 1, further comprising:
controlling distribution of the fluid through the smart material controlled slots for enhancing the fluid thickness at various percentages of the chord length along the span length to change twist of the aerodynamic surfaces.

10. An aerodynamic structure, comprising:
aerodynamic surfaces having moveable control surfaces; and
smart material controlled slots formed along span length and chord length of the aerodynamic surfaces and leading edges of the moveable control surfaces, wherein fluid is distributed on the aerodynamic surfaces and the leading edges of the moveable control surfaces through the smart material controlled slots to vary fluid thickness of a boundary layer such that free stream fluid paths are modified around the aerodynamic surfaces to achieve an apparent change in thickness and a camber.

11. The aerodynamic structure of claim 10, wherein the smart materials comprise at least one of piezoelectric materials, shape memory alloys and composite skins with integrated shape memory alloys.

12. The aerodynamic structure of claim 10, wherein the fluid comprises air obtained from at least one of cabin outlets, engine bleed, and avionics cooling outlets of an aircraft.

13. The aerodynamic structure of claim 10, wherein the aerodynamic surfaces comprise aircraft wing surfaces, vertical tail plane surfaces, horizontal tail plane surfaces and stabilizer surfaces.

14. The aerodynamic structure of claim 10, wherein the moveable control surfaces comprise ailerons, flaps, slats, elevators, and rudders.

15. The aerodynamic structure of claim 10, wherein the smart material controlled slots are provided at positions, beginning before a laminar flow separation point, of about 10%-75% of the chord length of the aerodynamic surfaces.

16. The aerodynamic structure of claim 10, wherein the smart material controlled slots comprise at least one of variable sized slots and fixed sired slots.

17. The aerodynamic structure of claim 10, wherein the smart material controlled slots comprise at least one of slots controlled by actuators made of smart materials and slots formed of smart materials.
